(19) United States
(12) Patent Application Publication
(10) Pub. No.: US 2025/0138923 A1
(43) Pub. Date: May 1, 2025

(54) Method and Apparatus for Data Synchronization and Persistence Between Computing Devices

(71) Applicant: Crowdstrike, Inc., Sunnyvale, CA (US)

(72) Inventor: James Michael Schofield, Apple Valley, MN (US)

(21) Appl. No.: 18/383,791

(22) Filed: Oct. 25, 2023

(51) Int. Cl. G06F 9/54; G06F 16/27

(52) U.S. Cl. CPC G06F 9/548; G06F 9/544; G06F 16/27

(57) ABSTRACT

A computing system includes a first computing device that executes an object-oriented software application which maintain objects, for example, in a heap data structure, in memory. The object-oriented software application includes an API to convert between objects in the memory and data in a relational database and transmit requests to perform one or more operations involving the data in the relational database corresponding to the objects in the memory. A decorator layer in communication with the API identifies the objects in the memory corresponding to the transmitted requests to perform one or more operations involving the data in the relational database. A local object storage API transfers copies of the identified objects to a local data store. A persistence API, in communication with the decorator layer and the object storage API, synchronizes the copied objects in the local data store with the data involved in the requests to perform the one or more operations with the relational database.

### CROSS REFERENCE TO RELATED DOCUMENTS

N/A

### TECHNICAL FIELD

Embodiments of the invention relate to client-server or distributed computing systems in which object-oriented data maintained at one computing device may be mapped or converted to data in a relational database accessible via a different computing device, and modifications to the data accessible to either computing device may be synchronized and persisted in the other computing device.

### BACKGROUND

Most computing systems today involve distributed computing of some kind, in which an end user has access to the computing system via a client computing device in a client-server computing system, a computing node in a distributed computing system, an access point device in a cloud computing system, or an end user computing device such as a desktop, lap top, or a smart phone, for example, running a progressive web application, with access to the world wide web, or simply, the web, via the Internet, a cellular network, a private communications network, or combinations thereof. A user's request to access data, whether to add data to, modify data in, or delete data from an online or remote data repository, can be relatively slow to process, or the process itself can be interrupted, if the communications over the Internet, cellular network, private communications network, or combinations thereof, are operating slowly or have stopped, and/or if the servers, applications and/or databases with which the end user's computing device is communicating are busy or offline.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows a computing system in which embodiments of the invention may be practiced.

FIG. 2 shows aspects of the computing system illustrated in FIG. 1.

FIG. 3 shows an example flowchart according to embodiments of the invention.

FIG. 4 shows an example flowchart according to embodiments of the invention.

FIG. 5 shows an example flowchart according to embodiments of the invention.

### DETAILED DESCRIPTION

Embodiments of the invention relate to a computing system that includes a first computing device which executes an object-oriented software application that maintains objects in, for example, a heap data structure, in a memory of the first computing device. The object-oriented software application includes an API with object-relational mapping capabilities to convert between objects in the memory and data in a relational database and transmit requests to perform one or more operations involving the data in the relational database corresponding to the objects in the memory, such as create, read, update, delete, and upsert operations. A decorator layer in communication with the API identifies the objects in the memory corresponding to the transmitted requests to perform one or more operations involving the data in the relational database. A local object storage API transfers copies of the identified objects to a local data store. A persistence API, in communication with the decorator layer and the local object storage API, synchronizes the copied objects in the local data store with the data involved in the requests to perform the one or more operations with the relational database.

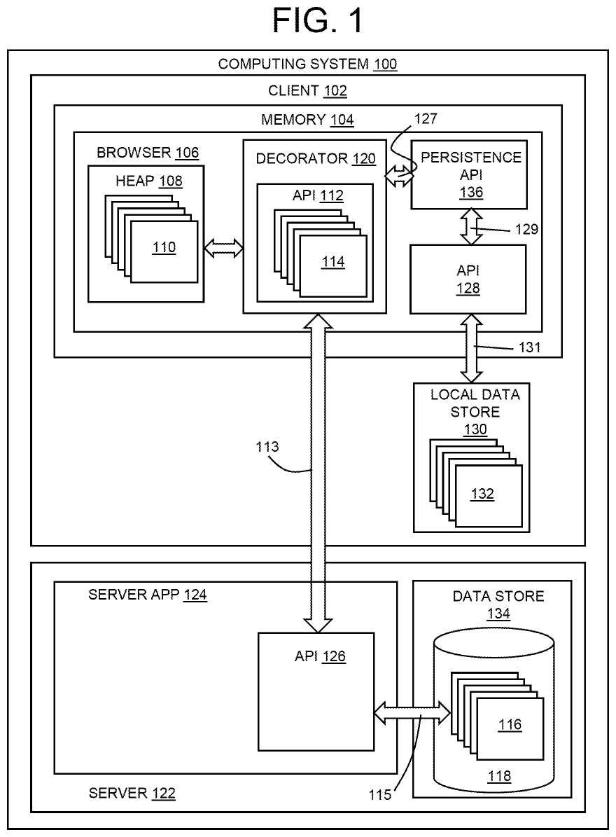

FIG. 1 depicts a computing system 100 in which example embodiments of the invention may operate. The computing system includes a computing device 102, for example, a client computing device in a client-server computing system, a computing node in a distributed computing system, an access point device in a cloud computing system, or an end user computing device such as a desktop, lap top or smart phone with access to the world wide web, or simply, the web, via the Internet, a cellular network, a private communications network, or combinations thereof.

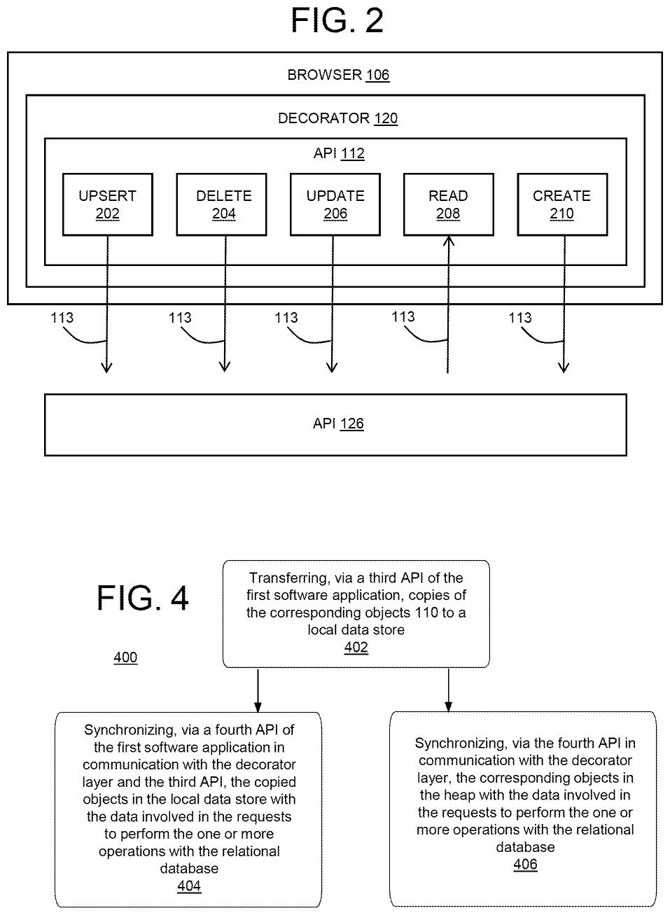

The computing device 102 includes a memory 104. An object-oriented software application 106, for example, a web browser, a file or document management application, or an email application, executes on the computing device 102 and maintain objects 110 in a heap data structure 108 (“heap”) in the memory 104 of the computing device 102. The software application 106 uses an Application Programmatic Interface (API) 112 to convert, or map, between objects 110 in the heap 108 and data 116 in a relational database 118 and transmit requests as depicted at 113 to perform one or more operations 114 involving the data 116 in the relational database 118 corresponding to the objects 110 in the heap 108. Such operations are illustrated in FIG. 2 and may include but are not limited to create 210, read 208, update 206, delete 204, and upsert 202 operations. The term upsert is a portmanteau—a combination of the words “update” and “insert.” In the context of relational databases, an upsert is a database operation that will update an existing row if a specified value already exists in a table and insert a new row if the specified value doesn't already exist. Example embodiments may employ an Object Relational Mapper (ORM) at or in conjunction with API 112. An ORM is a piece of software that translates between the data representations used by databases and the data representations used in object-oriented programming. Basically, these two ways of working with data do not naturally fit together, so an ORM attempts to bridge the gap between the two systems' data designs. The essence of the problem involves translating the logical representation of the objects into an atomized form that is capable of being stored in the relational database while preserving the properties of the objects and their relationships so that they can be reloaded as objects when needed. If this storage and retrieval functionality is implemented, the objects are said to be persistent.

The computing system 100 also includes a second computing device 122, for example, a server computing device in a client-server computing system, a web server connected to the Internet that provides the web pages that one sees when they are connected at an end user device to the web, or a file, document management, or email server that stores and manages files, documents, or emails that one can access when connected to a filesystem, document management system, or email system from an end user device. Computing device 122 includes or has access to a persistent data store 134 that holds the relational database 118. A software application 124, for example, a web-, file-, document management-, or email server application, executing on the computing device 122 has access as depicted at 115 to the data 116 in the relational database 118. The software application 124 includes an API 126 to receive the requests 113 from API 112 to perform the one or more operations 114 involving the data 116 in the relational database 118.

As noted above, computing system 100 includes computing device 102. Computing device 102 includes or has access to a local data store 130. The software application 106 includes a local object storage API 128 via which to transfer as depicted at 131 copies 132 of the corresponding objects 110 to the local data store 130. For example, software application 106 may be a web browser, and the local object storage API 128 may be one or more web APIs such as but not limited to the well-known IndexedDB API, the File API, or the LocalStorage API). The IndexedDB API is a low-level API for client-side storage of significant amounts of structured data, including files/blobs, and provides the ability to persistently store data inside a user's browser, regardless of network availability, so applications can work both online and offline—while there is no Internet or network connection. The File API provides for representing file objects in web applications, as well as programmatically selecting them and accessing their data. The localStorage API acts as a local cache that stores the data with no expiration date, so the data will not be deleted when the web browser is interrupted or closed, and will be available the next day, week, or year. These web APIs may be used in conjunction with other APIs and elements on the web platform, such as Web Workers. A Web Worker, as defined by the World Wide Web Consortium (W3C) and the Web Hypertext Application Technology Working Group (WHATWG), is a JavaScript script executed from an HTML page that runs in the background, independently of scripts that may also have been executed from the same HTML page. Web Workers may be long-running scripts that are not interrupted by scripts that respond to clicks or other user interactions. Keeping such workers from being interrupted by user activities should allow web pages to remain responsive at the same time as they are running long tasks in the background.

A decorator design pattern, or simply, a decorator layer, 120 in communication with the API 112 identifies objects 110 in the heap 108 corresponding to the transmitted requests 113 to perform one or more operations involving the data 116 in the relational database 118. Decorators are functions that can apply to a class, a class property, a class method, a class accessor, or a class method parameter in an object-oriented programming environment. There are five corresponding types of decorators that may be used, including class decorators, property decorators, method decorators, accessor decorators and parameter decorators. The decorator design pattern is a programming technique to dynamically add or extend the functionality of classes or functions or methods without modifying them. The decorator design pattern allows mixing and matching extensions to classes without creating subclasses and affecting the behavior of other objects of the same class. By using the decorator pattern and applying the same to class methods, embodiments can generate different permutations of functionality as may be desired without creating an increasing number of subclasses that would otherwise result in code that is increasingly complex and bloated. Decorators are usually implemented as sub-interfaces of a main interface to be implemented and store an object of the main interface's type. The decorator will then modify the method (or methods) to which it wants to add certain functionality by overriding the method(s) in the interface and calling on methods from the stored object.

The software application 106 further includes a persistence API 136 in communication with the decorator layer 120 as depicted at 127 and the API 128 as depicted at 129 to mirror or synchronize the copied objects 132 in the local data store 130 with the data 116 involved in the requests 113 to perform the one or more operations 114 with the relational database 118. Additionally, or alternatively, the persistence API 136 is in communication with the decorator layer 120 as depicted at 127 to mirror or synchronize the corresponding objects 110 in the heap 108 with the data 116 involved in the requests 113 to perform the one or more operations 114 with the relational database 118.

In an example embodiment, software application 106 includes a user interface (not shown) via which to receive user input to access at least some of the data involved in the requests to perform the one or more operations 114 with the relational database 118. For example, a web browser application may provide a window in which a user may provide input, such as an HTTP, create, read, update, delete, or upsert request relating to at least some of the data involved in the requests to perform the one or more operations 114 with the relational database 118. In response, the software application 106 may access the at least some of the data from the local data store 130 responsive to the persistence API 136 in communication with the decorator layer 120 to mirror or synchronize the corresponding copied objects 132 in the local data store 130 with the data 116 involved in the requests 113 to perform the one or more operations 114 with the relational database 118. Additionally, or alternatively, in response, the software application 106 may access the at least some of the data from the heap 108 responsive to the persistence API 136 in communication with the decorator layer 120 to mirror or synchronize the corresponding objects 110 in the heap 108 with the data involved in the requests 113 to perform the one or more operations 114 with the relational database 118.

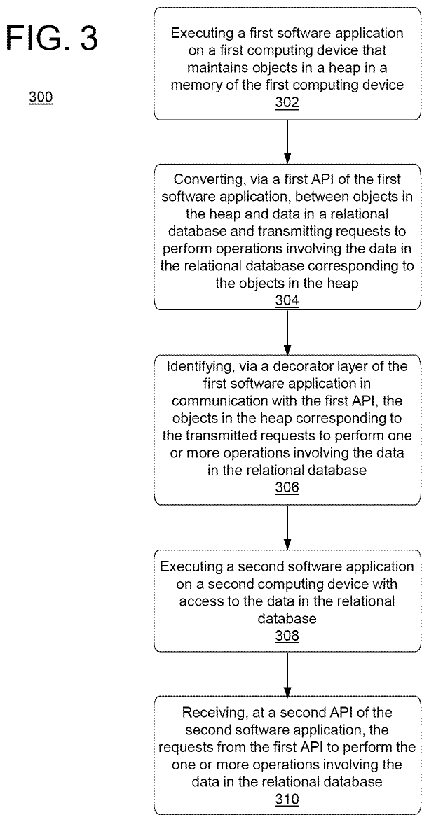

FIG. 3 shows a flow chart of a computer-implemented method 300 according to example embodiments. At step 302, the method executes an object-oriented software application 106 (e.g., a web browser) on a first computing device (e.g., a client or end user computing device 102) that maintain objects 110 in a heap data structure 108 (“heap”) in a memory 104 of the computing device 102. At step 304, the method converts, via API 112 of the software application 106, between objects 110 in the heap and data 116 in a relational database 118 and transmits requests 113 to perform one or more operations 114 involving the data 116 in the relational database 118 corresponding to the objects 110 in the heap 108. The method identifies, at step 306, via a decorator layer 120 of the software application 106 in conjunction with the API 112, the objects 110 in the heap 108 corresponding to the transmitted requests 113 to perform one or more operations 114 involving the data 116 in the relational database 118. In one example, the method transmits requests to perform one or more operations involving data in the relational database such create, read, update, delete, and upsert operations. In one example embodiment, the operations are implemented as methods, and the decorator layer 120 is declared a method decorator. The decorator layer is applied to a property descriptor for the methods, and can be used to observe, modify, or replace a method definition. In another example, the decorator layer 120 comprises a separate decorator method for each individual method, i.e., a decorator method for the create method, another, separate decorator method for the update method, and so on.

In one example embodiment, the computer-implemented method further executes at step 308 a second software application 124 (e.g., a server application) on a second computing device 122 (e.g., a server) with access as depicted in FIG. 1 at 115 to the data 116 in the relational database 118, and receives, at step 310, at an API 126 of the software application 124, the requests 113 from the API 112 to perform the one or more operations 114 involving the data 116 in the relational database 118.

With reference to the flowchart 400 depicted in FIG. 4, in another example embodiment, the computer-implemented method transfers at step 402, via another API 128 (such as the IndexedDB API, the File API, or the LocalStorage API mentioned above) for the software application 106, copies 132 of the corresponding objects 110 to a local data store 130 in or accessible to the computing device 102. This example embodiment may also synchronize at step 404, via a persistence API 136 of the software application 106 in communication with the decorator layer 120 as depicted at 127 and the API 128 as depicted at 129, the copied objects 132 in the local data store 130 with the data 116 involved in the requests 113 to perform the one or more operations 114 with the relational database 118. Additionally, or alternatively, the computer-implemented method may also synchronize at step 406, via the persistence API 136 in communication with the decorator layer 120 as depicted at 127, the corresponding objects 110 in the heap with the data 116 involved in the requests 113 to perform the one or more operations 114 with the relational database 118.

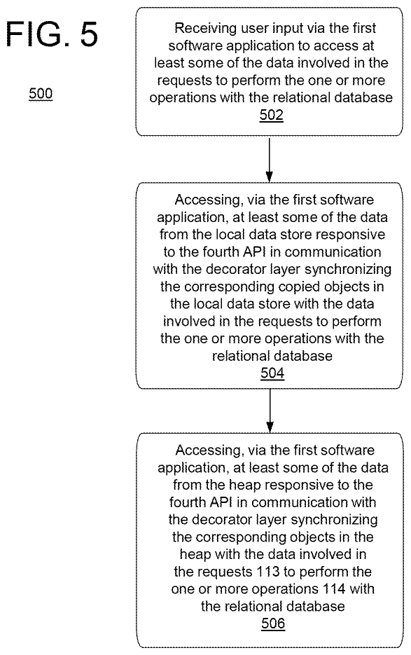

With reference to the flowchart 500 depicted in FIG. 5 in one example embodiment, the computer-implemented method may receive user input at step 502 via the software application 106 to access at least some of the data involved in the requests to perform the one or more operations 114 with the relational database 118. The method may then access at step 504, via the software application 106, the at least some of the data from one of the local data store 130 responsive to the persistence API 136 in communication with the decorator layer 120 mirroring or synchronizing the corresponding copied objects 132 in the local data store 130 with the data 116 involved in the requests 113 to perform the one or more operations 114 with the relational database 118. Additionally, or alternatively, the method may then access at step 506, the heap responsive to the persistence API 136 in communication with the decorator layer 120 synchronizing the corresponding objects 110 in the heap 108 with the data involved in the requests 113 to perform the one or more operations 114 with the relational database 118.

A computing system associated with the embodiments described herein can be a server, computer, or other type of computing device that executes one or more instances of the software discussed herein. In some examples, the software can be executed by a dedicated computing system. In other examples, the computing system can execute one or more instances of the software via virtual machines or other virtualized instances. For instance, the computing system may execute multiple instances of the software in parallel, using different virtual machines, parallel threads, or other parallelization techniques.

The computing system can include memory. In various examples, the memory can include system memory, which may be volatile (such as RAM), non-volatile (such as ROM, flash memory, non-volatile memory express (NVMe), etc.) or some combination of the two. The memory can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the computing system. Any such non-transitory computer-readable media may be part of the computing system.

The memory can store data, algorithms, and/or any other element of the embodiments disclosed herein. The memory can also store other modules and data. The modules and data can include any other modules and/or data that can be utilized by the computing system to perform or enable performing the actions described herein. Such other modules and data can include a platform, operating system, and applications, and data utilized by the platform, operating system, and applications.

By way of a non-limiting example, the computing system that executes the software may have non-volatile memory, such as an NVMe disk configured to store a file system volume, algorithms, and/or any other element of the embodiments disclosed herein. The computing system may also have volatile memory, such as synchronous dynamic RAM (SDRAM), double data rate (DDR) SDRAM, DDR2 SDRAM, DDR3 SDRAM, or DD4 SDRAM.

The computing system can also have one or more processors. In various examples, each of the processors can be a central processing unit (CPU), a graphics processing unit (GPU), both a CPU and a GPU, or any other type of processing unit. Each of the one or more processors may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processors may also be responsible for executing computer applications stored in the memory, which can be associated with types of volatile and/or nonvolatile memory.

The computing system can also have one or more communication interfaces. The communication interfaces can include transceivers, modems, interfaces, antennas, telephone connections, and/or other components that can transmit and/or receive data over networks, telephone lines, or other connections. For example, the communication interfaces can include one or more network cards that can be used to receive inputs and output results according to the above embodiments.

In some examples, the computing system can also have one or more input devices, such as a keyboard, a mouse, a touch-sensitive display, voice input device, etc., and/or one or more output devices such as a display, speakers, a printer, etc. These devices are well known in the art and need not be discussed at length here.

The computing system may also include a drive unit including a machine-readable medium. The machine-readable medium can store one or more sets of instructions, such as software or firmware, that embodies any one or more of the methodologies or functions described herein. The instructions can also reside, completely or at least partially, within the memory, processor(s), and/or communication interface(s) during execution thereof by the computing system. The memory and the processor(s) also can constitute machine readable media.

Although the invention has been described and illustrated in the foregoing illustrative examples, it is understood that numerous changes in the details of implementation of the invention can be made without departing from the spirit and scope of the invention, which is only limited by the claims that follow. Features of the disclosed embodiments can be combined and rearranged in various ways.

What is claimed is:

1. A computing system, comprising:
a first computing device;
a memory in the first computing device;
a first, object-oriented, software application executing on the first computing device that maintains objects in the memory of the first computing device, the first software application comprising:
a first Application Programmatic Interface (API) to convert between objects in the memory and data in a relational database, and transmit requests to perform one or more operations involving the data in the relational database corresponding to the objects in the memory; and
a decorator layer in communication with the first API to identify the objects in the memory corresponding to the transmitted requests to perform one or more operations involving the data in the relational database.

2. The computing system of claim 1, wherein the first API to transmit requests to perform one or more operations involving data in the relational database corresponding to the objects comprises transmitting requests to perform one or more operations selected from a group of operations consisting of: create, read, update, delete, and upsert operations.

3. The computing system of claim 1, further comprising:
a second computing device;
a persistent data store, accessible to the second computing device, that holds the relational database; and
a second software application executing on the second computing device with access to the data in the relational database, the second software application comprising a second API to receive the requests from the first API to perform the one or more operations involving the data in the relational database.

4. The computing system of claim 1, further comprising:
a local data store accessible to the first computing device; and
wherein the first software application further comprises a third API via which to transfer copies of the corresponding objects to the local data store.

5. The computing system of claim 4, wherein the first software application is a web browser application executing on the first computing device, and wherein the third API is selected from a group of world wide web APIs consisting of: an IndexedDB API, a File API, and a LocalStorage API.

6. The computing system of claim 4, wherein the first software application further comprises a fourth API in communication with the decorator layer and the third API to synchronize the copied objects in the local data store with the data involved in the requests to perform the one or more operations with the relational database.

7. The computing system of claim 6, wherein the fourth API further is in communication with the decorator layer to synchronize the corresponding objects in the memory with the data involved in the requests to perform the one or more operations with the relational database.

8. The computing system of claim 6, wherein the first software application comprises a user interface via which to receive user input to access at least some of the data involved in the requests to perform the one or more operations with the relational database; and
the first software application accessing the at least some of the data from one of:
the local data store responsive to the fourth API in communication with the decorator layer to synchronize the corresponding copied objects in the local data store with the data involved in the requests to perform the one or more operations with the relational database, and
the memory responsive to the fourth API in communication with the decorator layer to synchronize the corresponding objects in the memory with the data involved in the requests to perform the one or more operations with the relational database.

9. A computer-implemented method, comprising:
executing a first, object-oriented, software application on a first computing device that maintains objects in a memory of the first computing device;
converting, via a first Application Programmatic Interface of the first software application, between objects in the memory and data in a relational database and transmitting requests to perform one or more operations involving the data in the relational database corresponding to the objects in the memory; and
identifying, via a decorator layer of the first software application in communication with the first API, the objects in the memory corresponding to the transmitted requests to perform one or more operations involving the data in the relational database.

10. The computer-implemented method of claim 9, wherein transmitting requests to perform one or more operations involving data in the relational database corresponding to the objects comprises transmitting requests to perform one or more operations selected from a group of operations consisting of: a create, a read, an update, a delete, and an upsert method.

11. The computer-implemented method of claim 9, further comprising:
executing a second software application on a second computing device with access to the data in the relational database; and
receiving, at a second API of the second software application, the requests from the first API to perform the one or more operations involving the data in the relational database.

12. The computer-implemented method of claim 9, further comprising:
transferring, via a third API of the first software application, copies of the corresponding objects to a local data store accessible to the first computing device.

13. The computer-implemented method of claim 12, further comprising synchronizing, via a fourth API of the first software application in communication with the decorator layer and the third API, the copied objects in the local data store with the data involved in the requests to perform the one or more operations with the relational database.

14. The computer-implemented method of claim 13, further comprising synchronizing, via the fourth API in communication with the decorator layer, the corresponding objects in the memory with the data involved in the requests to perform the one or more operations with the relational database.

15. The computer-implemented method of claim 13, further comprising:
receiving user input via the first software application to access at least some of the data involved in the requests to perform the one or more operations with the relational database; and
accessing, via the first software application, the at least some of the data from one of:
the local data store responsive to the fourth API in communication with the decorator layer synchronizing the corresponding copied objects in the local data store with the data involved in the requests to perform the one or more operations with the relational database, and
the memory responsive to the fourth API in communication with the decorator layer synchronizing the corresponding objects in the memory with the data involved in the requests to perform the one or more operations with the relational database.

16. One or more non-transitory computer-readable media storing computer-executable instructions, when executed by one or more processors, cause the one or more processors to perform operations comprising:
executing a first, object-oriented, software application on a first computing device that maintains objects in a memory of the first computing device;
converting, via a first Application Programmatic Interface of the first software application, between objects in the memory and data in a relational database and transmitting requests to perform one or more operations involving the data in the relational database corresponding to the objects in the memory; and
identifying, via a decorator layer of the first software application in communication with the first API, the objects in the memory corresponding to the transmitted requests to perform one or more operations involving the data in the relational database.

17. The one or more non-transitory computer-readable media of claim 16, further comprising:
executing a second software application on a second computing device with access to the data in the relational database; and
receiving, at a second API of the second software application, the requests from the first API to perform the one or more operations involving the data in the relational database.

18. The one or more non-transitory computer-readable media of claim 16, further comprising:
transferring, via a third API of the first software application, copies of the corresponding objects to a local data store accessible to the first computing device.

19. The one or more non-transitory computer-readable media of claim 18, further comprising:
synchronizing, via a fourth API of the first software application in communication with the decorator layer and the third API, the copied objects in the local data store with the data involved in the requests to perform the one or more operations with the relational database.

20. The one or more non-transitory computer-readable media of claim 18, further comprising:
synchronizing, via the fourth API in communication with the decorator layer, the corresponding objects in the memory with the data involved in the requests to perform the one or more operations with the relational database.
